(19) United States
(12) Patent Application Publication
(10) Pub. No.: US 2008/0174625 A1
(43) Pub. Date: Jul. 24, 2008

(54) INKJET PRINTER, IMAGE FORMING METHOD AND IMAGE QUALITY COMPENSATION METHOD THEREOF

(75) Inventor: Hyoung-dong CHOI, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/972,739

(22) Filed: Jan. 11, 2008

(30) Foreign Application Priority Data
Jan. 18, 2007 (KR) 2007-5761

(51) Int. Cl. B41J 29/38

(52) U.S. Cl. 347/16

(57) ABSTRACT

An inkjet printer, an image forming method and an image quality compensation method thereof compensate for an image quality deviation in the ink jet printer. The method includes forming a first image on a printing medium fed at a first position, shifting the printing medium having the first image in a transverse direction to a feeding direction of the printing medium; forming a second image on the printing medium fed at the shifted position, and detecting a real shift amount of the printing medium by scanning the first and second images.

### CROSS-REFERENCE TO RELATED APPLICATIONS

This application claims priority under 35 U.S.C. §119(a) from Korean Patent Application No. 10-2007-0005761, filed on Jan. 18, 2007 in the Korean Intellectual Property Office, the disclosure of which is incorporated herein by reference in its entirety.

### BACKGROUND OF THE INVENTION

1. Field of the Invention

The present general inventive concept relates to an ink jet printer and an image forming method thereof, and more particularly, to an ink jet printer capable of shifting a printing medium in a transverse direction to a feeding direction.

2. Description of the Related Art

In general, an ink jet printer jets tiny droplet of ink for printing in a wanted position on a printing medium to form an ink image.

The ink jet printer is provided with a head in which nozzles are formed for jetting ink. The head of the ink jet printer can be classified into a shuttle type in which the head moves along a transverse direction to a feeding direction of the printing medium to form a line of ink image, and an array type in which nozzles are disposed as wide as the width of the printing medium along the transverse direction to form a line of ink image at a time.

Since the array type head has a much faster printing speed in comparison with the shuttle type head, it has been developed for a high-speed printing.

However, if there are any inferior nozzles among plural nozzles of the array type head, ink is not jetted for an image formed through the concerned inferior nozzles to make blank image, or ink is not jetted properly to make blurred image to be outputted, thereby deteriorating printing image quality.

### SUMMARY OF THE INVENTION

The present general inventive concept provides an ink jet printer capable of compensating for printing image quality caused by an inferior nozzle and an image forming method thereof.

The present general inventive concept also provides an ink jet printer which can provide various image forming methods, thereby enabling a user to select one of the methods.

Additional aspects and utilities of the present general inventive concept will be set forth in part in the description which follows and, in part, will be obvious from the description, or may be learned by practice of the general inventive concept.

The foregoing and/or other aspects of the present general inventive concept can be achieved by providing a method of compensating for an image quality deviation in an ink jet printer, the method including forming a first image on a printing medium fed at a first position, shifting the printing medium having the first image in a transverse direction to a feeding direction of the printing medium, forming a second image on the printing medium fed at the shifted position, and detecting a real shift amount of the printing medium by scanning the first and second images.

The method may further include determining the type of printing medium.

The method may further include storing the detected real shift amount according to the types of printing medium.

The foregoing and/or other aspects of the present general inventive concept can also be achieved by providing a method of forming an image in an ink jet printer having an image forming part arranged wider than a feeding directional width of a printing medium to jet ink, the method including determining whether a printing mode is in a normal printing mode or a transposition printing mode, printing an image on the printing medium in case of the normal printing mode, and printing an image on the printing medium shifted in a transverse direction to the feeding direction in case of the transposition printing mode.

The method may further include determining whether the printing mode is in an image quality deviation compensating mode, and in the image quality deviation compensating mode, alternately printing first and second images on the printing medium according to the normal printing mode and the transposition printing mode, and detecting a real shift amount of the printing medium by scanning the first and second images.

The method may further include determining the type of printing medium; and storing the detected real shift amount according to the types of printing medium.

The method may further include determining whether the printing mode is in an image compensating mode, and in the image quality compensating mode, printing a third image and a fourth image shifted from the third image by a distance as much as the real shift amount on the printing medium according to the normal printing mode and the transposition printing mode.

The foregoing and/or other aspects of the present general inventive concept can also be achieved by providing an ink jet printer including an image forming part which is arranged wider than a feeding directional width of a printing medium and jets ink, a transposition part which shifts the printing medium in a transverse direction to the feeding direction, a scanning part which scans an image formed by the image forming part, and a controller which controls the image forming part, the transposition part and the scanning part to form a first image and a second image on the printing media fed from a first position and a second position spaced apart from the first position in the transverse direction by a distance as much as the shift amount, respectively, and to detect a real shift amount by scanning the first image and the second image.

The ink jet printer may further include a memory part, and the controller may determine a type of printing medium and stores the real shift amount according to the determined type of printing medium in the memory part.

In an image quality compensating mode, the controller may control the image forming part and the transposition part to print a first image on the printing medium fed at the first position, to shift the print medium on which the first image is printed, and to print a second image shifted from the first image as much as the real shift amount on the shifted printing medium.

The foregoing and/or other aspects of the present general inventive concept can also be achieved by providing an image forming apparatus including an image forming part having a length wider than a feeding directional width of a printing medium, a transposition part to shift the printing medium in a transverse direction perpendicular to a feeding direction of the printing medium to a first position and a second position, and a controller to determine whether a printing mode is in a normal printing mode or a transposition printing mode, to control the image forming part to print an image on the printing medium in the normal printing mode, and to print the image on the printing medium shifted in the transverse direction in the transposition printing mode.

The foregoing and/or other aspects of the present general inventive concept can also be achieved by providing an image forming apparatus including an image forming part, a transposition part to shift the printing medium to a first position and a second position in a transverse direction perpendicular to a feeding direction of the printing medium, and a controller to control the image forming part to print an image on the printing medium in the first position and the second position.

The foregoing and/or other aspects of the present general inventive concept can also be achieved by providing a method of an image forming apparatus, the method including shifting the printing medium to a first position and a second position in a transverse direction perpendicular to a feeding direction of the printing medium, and controlling an image forming part to print an image on the printing medium in the first position and the second position.

The foregoing and/or other aspects of the present general inventive concept can also be achieved by providing a method of an image forming apparatus, the method including forming an image on a printing medium according to image data assigned to a first portion of an image forming part, and forming the image on the printing medium with the image according to the image data assigned to a second portion of the image forming part.

The foregoing and/or other aspects of the present general inventive concept can also be achieved by providing an image forming apparatus including an image forming part having a first portion and a second portion, and a controller to control the image forming part to form an image on a printing medium according to image data assigned to a first portion of an image forming part, and to form the image on the printing medium with the image according to the image data assigned to a second portion of the image forming part.

The first portion and a second portion may overlap to have a common portion to be used to form the image on the printing medium disposed in the first position and the second position.

The image forming part may include a plurality of nozzles disposed along the traverse direction perpendicular to a feeding direction of the printing medium, the first portion may include a first group of the nozzles, the second portion may include a second group of the nozzles having a portion of the first group of the nozzles, and the first group of nozzles and the second group of nozzles may be used to form the image according to the same image data.

The first group of the nozzles and the second group of the nozzles may be a same number.

At least one of the first group of the nozzles and the second group of the nozzles may be a defective or inferior nozzle.

The foregoing and/or other aspects of the present general inventive concept can also be achieved by providing an image forming apparatus including an image forming part, a feeding roller to feed a printing medium, and a driving unit connected to the feeding roller to rotate the feeding roller about a rotation axis of the feeding roller, and to selectively shift the feeding roller in a direction of the rotation axis of the feeding roller.

### BRIEF DESCRIPTION OF THE DRAWINGS

These and/or other aspects and utilities of the present general inventive concept will become apparent and more readily appreciated from the following description of the embodiments, taken in conjunction with the accompanying drawings, in which:

FIG. 1 is a schematic sectional view illustrating an ink jet printer according to an embodiment of the present general inventive concept;

FIG. 2 is a plan view illustrating a main part of the ink jet printer of FIG. 1;

FIG. 3 is an enlarged perspective view illustrating a main part of a transposition part of the ink jet printer of FIG. 1;

FIG. 4 is a rear perspective view illustrating a second disk of the transposition part of FIG. 3;

FIG. 5 is a block diagram illustrating the ink jet printer of FIG. 1;

FIG. 6 is a schematic view illustrating a shift amount of a printing medium according to a normal printing mode and a transposition printing mode of the ink jet printer of FIG. 1;

FIG. 7 is an output exemplary view illustrating a printing medium in a case that the ink jet printer of FIG. 1 has an inferior nozzle;

FIGS. 8A to 8C are schematic views illustrating an image quality compensating mode of the ink jet printer of FIG. 1;

FIGS. 9A and 9B are schematic views illustrating an image quality deviation compensating mode of the ink jet printer of FIG. 1;

FIGS. 10A and 10B are exemplary views illustrating a data table before compensating a shift amount and an image shift amount according to a type of a printing medium stored in a memory part of the ink jet printer of FIG. 1, and a data table after compensating for the expected shift amount and an image shift amount by using a real value of a shift amount, respectively; and

FIGS. 11A, 11B, and 11C are flowcharts illustrating an image forming method according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

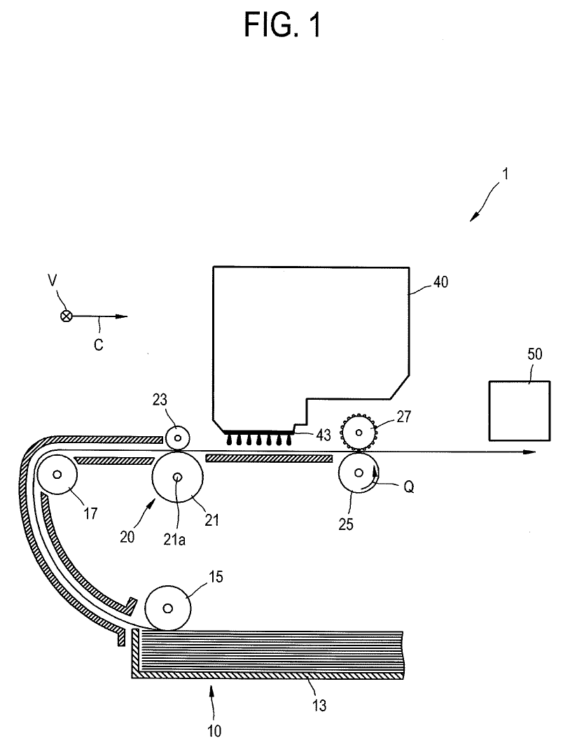

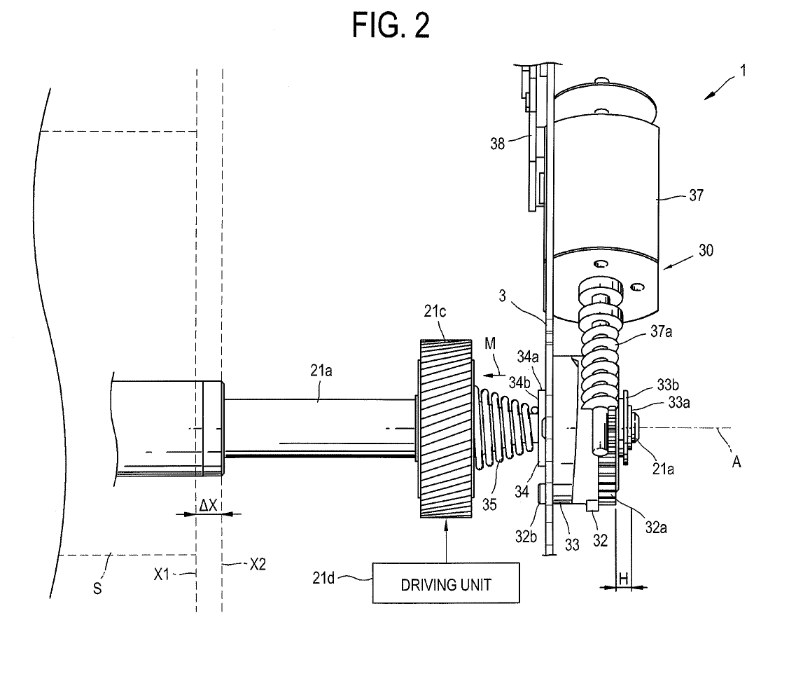

As illustrated in FIGS. 1 and 2, an image forming apparatus, such as an ink jet printer 1, according to an embodiment of the present general inventive concept comprises a paper feeding part 10, a medium transfer part 20, a transposition part 30, and an image forming part 40.

The paper feeding part 10 comprises a feeding cassette 13 which stores printing media to be supplied to the medium transfer part 20, a pick up roller 15 which separates and picks up the printing media one by one, and a feeding roller 17 which feeds the picked up printing medium to the medium transfer part 20.

The medium transfer roller 20 supplies the printing medium to the image forming part 40 in a waiting position before an image is formed.

As shown in FIG. 1, the medium transfer part 20 may include an idle roller 23 and a feed roller 21 which rotates about a rotational axis of the rotational shaft 21a, and is disposed in parallel with the idle roller 23 to feed the printing medium positioned between the two rollers 21 and 23 to the image forming part 40. The present general inventive concept is not limited thereto. The medium transfer part 20 may be a paper transfer belt, or may be changed in various shapes.

Meanwhile, as illustrated in FIG. 2, the transposition part 30 shifts the printing medium in a transverse direction V of FIG. 1, that is, a vertical direction of a horizontal direction on the paper or a direction perpendicular to a feeding direction C of FIG. 1.

For this purpose, the transposition part 30 shifts the feed roller 21 to a transverse direction in a state in which the printing medium is held between the idle roller 23 and the feed roller 21.

Here, a driving mechanism in which the transposition part 30 shifts the feed roller 21 in the transverse direction will be described in detail by referring to FIG. 2.

The feed roller 21 is coupled to integrally rotate with the rotational shaft 21a. Also, a feed roller driving gear 21C is coupled to integrally rotate with the rotational shaft 21a of the feed roller 21 and receive a driving force from a driving (feeding) unit, such as a feed roller driving motor 21d to rotate the feed roller 21.

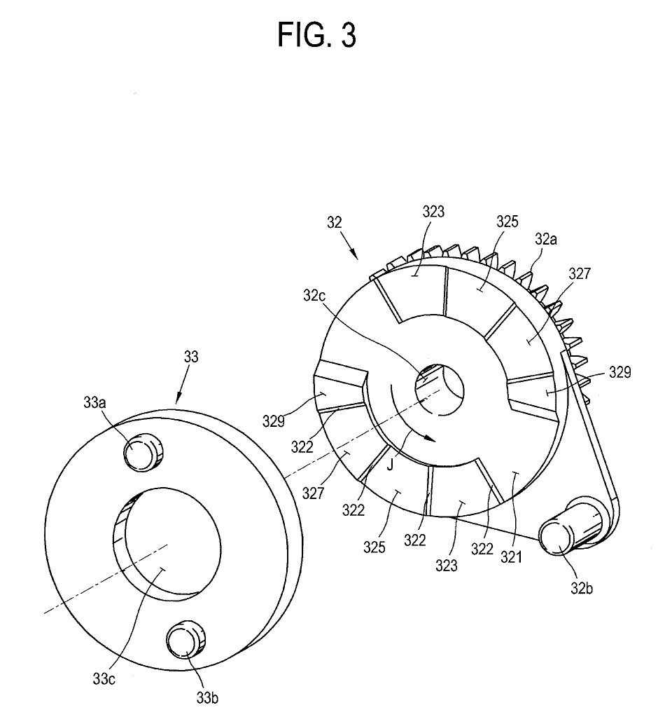

Meanwhile, an end part of the rotational shaft 21a of the feed roller 21 passes through a through hole 32c of a first disk 32 (see FIG. 3) and a through hole 33c of a second disk 33 (FIG. 3). The end part of the rotational shaft 21a is coupled to the first disk 32 to integrally move together with the first disk 32 along the transverse direction, more particularly, along an axial direction (or rotational axis direction) A of the rotational shaft 21a. A groove (not illustrated) is provided along a circumference surface in the end part of the rotational shaft 21a and a washer 33a is press-fitted to the groove, and accordingly, the rotational shaft 21a of the feed roller 21 can be integrally moved along the axial direction A as the first disk 32 rotates with respect to the axial direction A and/or moves along the axial direction A. Also, between the washer 33a and the first disk 32 may be further provided a friction preventing washer 33b so as to prevent abrasion thereof by friction.

Accordingly, the rotational shaft 21a of the feed roller 21 freely rotates with respect to the through hole 32c of the first disk 32 if the feed roller driving gear 21c is driven to rotate the first disk 32, and the rotational shaft 21a of the feed roller 21 moves in integration with the first disk 32 along the axial direction A if the first disk 32 moves along the axial direction A.

Meanwhile, as illustrated in FIG. 2, the transposition part 30 may comprise the first disk 32, the second disk 33, a first disk elastic medium member 34, an elastic member 35, and a first disk driving part 37.

As shown in FIG. 3, the first disk 32 comprises a first stair face to a fourth stair face 323, 325, 327, and 329 to project from a reference face (surface) 321 facing the second disk 33. The first to the fourth stair faces 323, 325, 327, and 329 are formed along a circumference direction of the first disk 32. Between the adjacent stair faces 323, 325, 327, and 329 is formed an inclined face 322 so that the first disk 32 can rotate with respect to the second disk 33. Also, as illustrated in FIG. 3, the stair faces 323, 325, 327, and 329 may be provided so that the projected height can be higher along a rotational direction J of the first disk 32. Also, each of the first to the fourth stair faces 323, 325, 327, and 329 can be provided to be symmetrical with respect to a rotational center along a direction of its diameter so that the first disk 32 can be stably supported to the second disk 33 in a state in which the first disk 32 has shifted in the transverse direction.

The inclined face 322 combining the reference face 321 and the fourth stair face 329 may be provided to have a large angle than an angle of the fourth stair face 329 to enable the first disk 32 to rotate only in one direction J, if necessary.

Also, the first disk 32 comprises a first disk driving gear 32a which is engaged with a worm gear 37a of the first disk driving part 37 to receive a rotational driving force. The first disk driving gear 32a is provided to integrally rotate with the first disk 32. The first disk driving gear 32a may be formed to be integrated with the first disk 32.

In addition, the first disk 32 may further comprise a guide projection 32b. The guide projection 32b is guided by a guide groove (not illustrated) formed on a portion of a side frame 3, and passes through the guide groove of the side frame 3. Accordingly, the rotational angle of the first disk 32 may be regulated by the guide groove, and the first disk 32 can rotate more smoothly. The guide projection 32b may be omitted, if necessary.

Meanwhile, the second disk 33 comprises the through hole 33c through which the first disk elastic medium member 34 passes, which will be described later. Also, the second disk 33 comprises one or more projections 33a, and the projection 33a is coupled to the side frame 3 to prevent the second disk 33 from rotating.

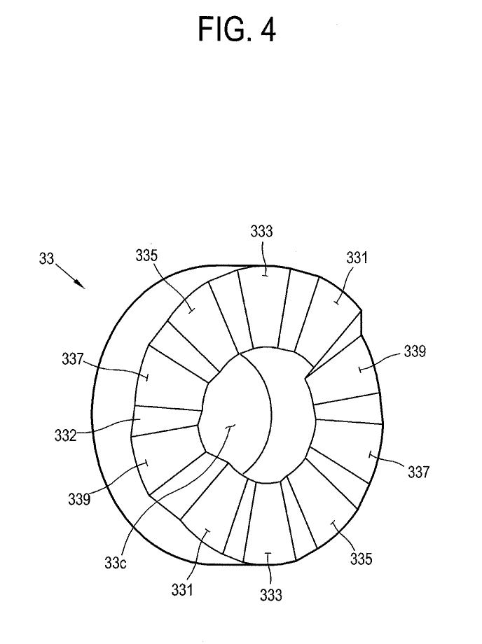

Referring to FIG. 4, on a facing surface 331 of the second disk 33, which faces the reference face 321 of the first disk 32 may be formed a fifth stair face to eighth stair face 333, 335, 337, and 339 corresponding to the first to the fourth stair faces 323, 325, 327, and 329 to be grooved in an opposite direction to the first disk 32 side.

That is, the fifth to the eighth stair faces 333, 335, 337, and 339 of the second disk 33 may be provided to be grooved by a corresponding depth with respect to the facing surface 331 along a circumference direction with respect to the facing surface 331 corresponding to the first to the fourth stair faces 323, 325, 327, and 329 of the first disk 32.

Accordingly, if the facing face 331 of the second disk 33 and the fifth to the eighth stair faces 333, 335, 337, and 339 are in contact with the reference face 321 of the first disk 32 and the first to the fourth stair faces 323, 325, 327, and 329 respectively, the printing medium S is positioned in an initial waiting position (or initial or original position) X1.

On the other hand, according as the first disk 32 rotates in the direction J, the first stair face 323 of the first disk 32 is in contact with the facing surface 331 of the second disk 33, and accordingly, the first disk 32 is separated from the second disk 33 by a projected height H of the first stair face 323. Here, for convenience's sake, the projected height H of FIG. 2 is illustrated to be greater than a real projected height of the first stair face 323 illustrated in FIG. 3. Accordingly, the feed roller 21 and the printing medium held in the feed roller 21 are shifted to a transposition waiting position X2 shifted as much as an expected shift amount ΔX from the initial waiting position X1.

Also, if the second stair face to the fourth stair faces 325, 327, and 329 of the first disk 32 are in contact with the facing surface 331 of the second disk 33, the expected shift amount ΔX can be set as much as a projected height H of each of the stair faces. The transposition waiting position X2 can be set as the first to the fourth transposition waiting positions corresponding to the projected height of the first to the fourth stair faces 323, 325, 327, and 329, as necessary. Accordingly, three or more printing operations are repeatedly performed with respect to an identical image in an image quality compensating mode to be described later, thereby obtaining a higher definition.

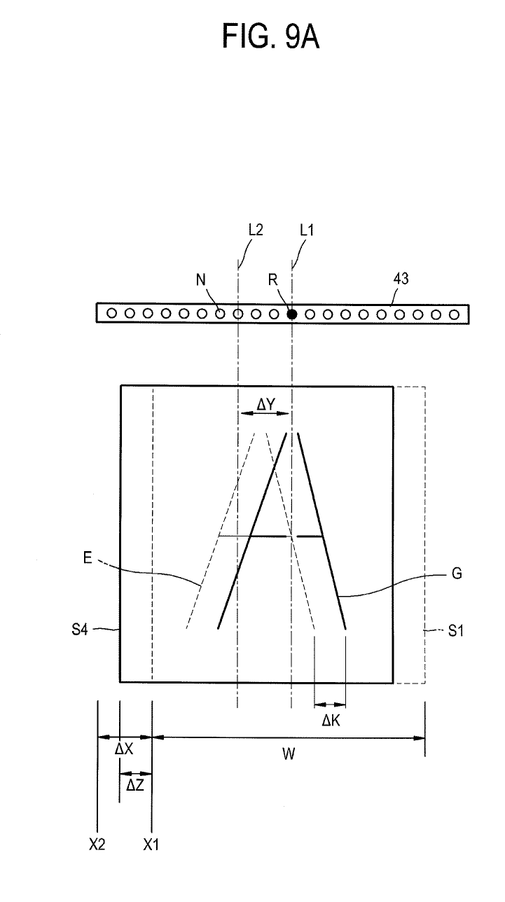

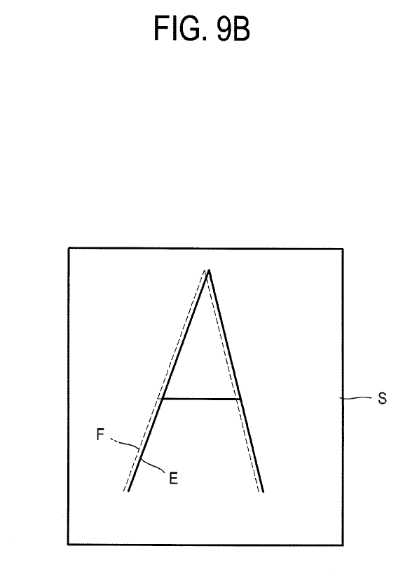

The expected shift amount ΔX and the shifted amount H of the first disk 32 with respect to the second disk 33, that is, the projected height H of the first stair face 323 may be considered to correspond to the expected shift amount ΔX, but deviation may occur between the real shift amount (see ΔZ in FIG. 9A) and the shift amount ΔX due to the shifted amount H of the first disk 32 by a mechanical error and abrasion through use. Accordingly, a compensating unit is needed for compensating the deviation, which will be described later.

Meanwhile, the first disk 32 may be rotated so that the second stair face 325 of the first disk 32 can be in contact with the facing surface 331 of the second disk 33 if the printing medium is to be shifted as much as the projected height of the second stair face 325 of the first disk 32 from the initial waiting position X1.

Since the shift amount ΔX depends on a length of the reference dace of the second disk 33 or a height of the reference stair dace of the first disk 21, the shift amount ΔX can be changed (increased or decreased) without limits by making the number and the projected height of the stair faces 323, 325, 327, and 329 of the first disk 32 different in the initial waiting position X1.

Meanwhile, the first disk elastic medium member 34 is mounted on the side frame 3 and inserted into the through hole 33c of the second disk 33 to support the second disk 33. The first disk elastic medium member 34 comprises a through hole (not illustrated) of which the center the rotational shaft 21a of the feed roller 21 is inserted into, a circumference projection 34a formed along a circumference thereof, and an elastic member seating part 34b in which the elastic member 35 is seated. The circumference projection 34a is in contact with the side frame 3 to restrict the first disk elastic medium member 34 from shifting to the axial direction A. Also, the elastic member 35 applies an elastic force to the feed roller driving gear 21c in a direction M. Accordingly, the first disk 32 which shifts integrally with the driven gear rotational shaft 21a to the axial direction A receives the elastic force in the direction M to prevent the first disk 32 and the second disk 33 from being disengaged from each other.

The elastic member 35 may be a coil spring. The elastic member 35 is inserted around the rotational shaft 21a of the feed roller 21 to be disposed between the feed roller driving gear 21c and the first disk elastic medium member 34.

The first disk driving part 37 may be an electric motor. The first disk driving part 37 may further comprise a worm gear 37a provided in an end part of the driving shaft of the first disk driving part 37 to be engaged with the first disk driving gear 32a. Also, the first disk driving part 37 may further comprise an encoder 38 and a decoder (not illustrated) to control the first disk driving part 37 since the rotational angle needs to be precisely controlled so as to regulate a shifted amount of the first disk 32 with respect to the second disk 33. The first disk driving part 37 and the driving unit 21d may be formed as a single driving part to control the shaft 21a to rotate about the rotational axis and to be moved (or shifted) in the rotational axis direction or the traverse direction.

Referring back to FIG. 1, the above-described type transposition part 30, a guide is provided along the feeding direction C of FIG. 1 of the printing medium to guide the printing medium to the feeding direction, and the guide is shifted in the transverse direction in response to the shifting movement of the shaft 21a, and accordingly, the printing medium may be shifted in the transverse direction. The guide can be disposed to be spaced-apart from the shaft 21a when the shaft 21a rotates, but disposed to move in the axial direction according to the shifting movement of the shaft 21a in the axial direction Also, the function of the transposition part 30 can be performed in other known various driving mechanisms in addition to the method illustrated in FIG. 2.

Meanwhile, the image forming part 40 forms an ink image on the printing medium transferred by the medium transfer part 20. The image forming part 40 comprises a head 43 which jets ink onto the printing medium.

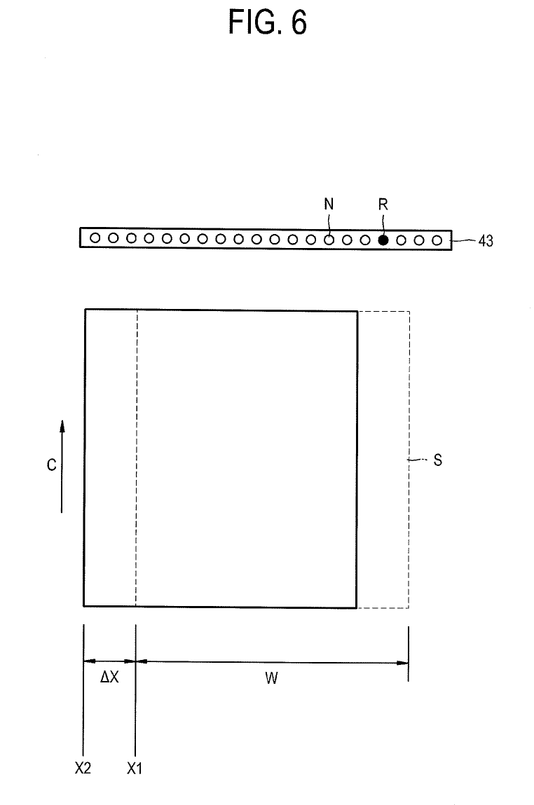

The head 43 is provided with plural nozzles N of FIG. 6 which are disposed along the transverse direction V of the feeding direction C of FIG. 1. Accordingly, a line of ink image can be printed on the printing medium at the same time.

Also, the image forming part 40 may further comprise an image processing part (not illustrated) which shifts the image data as much as an image shift amount along the transverse direction V of FIG. 1. That is, the image forming part 40 shifts the image data so as to form the same image superimposed on a normally-printed image on the shifted printing medium in the case of shifting the printing medium which has been fed in the initial waiting position X1 (see FIG. 2) and on which the normal printing image has been formed, to the transposition waiting position X2 (see FIG. 2) again. Meanwhile, the image shift amount denotes a value corresponding to the shifted amount of the first disk 32 of the transposition part 30.

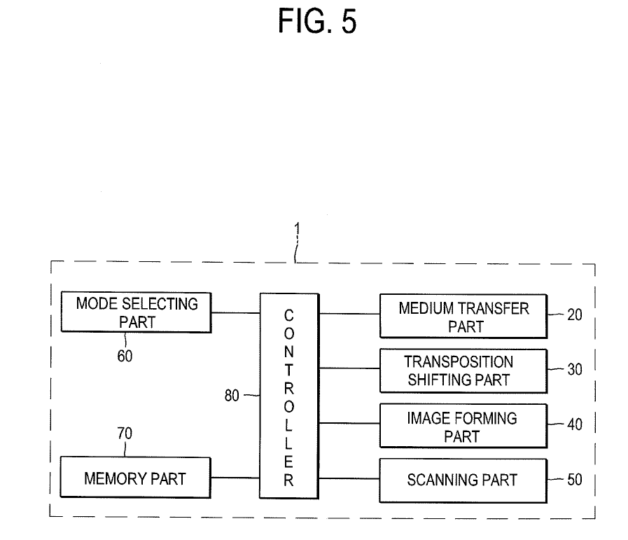

Referring to FIG. 5, the ink jet printer 1 according to the present general inventive concept may further comprise a scanning part 50, a mode selecting part 60, a memory part 70, and a controller 80.

The memory part 70 may store at least one of shift amount information and image transposition amount information. The memory part 70 may be provided as a read only memory (ROM) capable of reading and writing to prevent the image shift amount information from being deleted although a power supplied to the ink jet printer 1 is blocked or turned off. Also, the memory part 70 may be omitted as necessary in the case that the image shift amount is transmitted along with the image data from a user's host computer (not illustrated).

If only the shift amount information is stored in the memory part 70, the stored shift amount may be used as a value of the image shift amount of the image forming part 40 to be described later. Further, the shift amount information of the memory part 70, more particularly, the image transposition amount information may be updated using the detected real shift amount information which will be described later.

Referring to FIG. 1, the medium transfer part 20 may further comprise a reverse roller 25 and an idle roller 27 which return the printing medium fed from the initial waiting position X1 of FIG. 2 and on which an initial printing image has been formed for the initial printing at the initial waiting position X1 of FIG. 2, toward the image forming part 40 and/or the medium transfer part 20. If the reverse roller 25 rotates in a reverse direction N of FIG. 1, the printing medium may be returned toward the feed roller 21. Also, an additional return transferring path may be provided so that the printing medium can pass along it by communicating the reverse roller 25 with the feed roller 21, as necessary.

The mode selecting part 60 is an input device so that a user inputs one of a normal printing mode in which the printing medium is fed from the initial waiting position X1 of FIG. 2 and a normal printing image is formed by the image forming part 40, and a transposition printing mode in which the printing medium is fed from the transposition waiting position X2 of FIG. 2 and a transposition-printing image is formed by the image forming part 40. The mode selecting part 60 may be provided as a display panel (not illustrated) and an input key (not illustrated). For example, in a case that a mode can be automatically selected since there is an inferior nozzle sensor part (not illustrated) to sense a position of the inferior nozzle, the mode selecting part 60 may be omitted.

The scanning part 50 may comprise a charge coupled device (CCD) sensor or a contact image sensor (CIS). The scanning part 50 scans the normally-printed image and a second transposition-printed image to be described later in a case that an image quality deviation compensating mode (to be described later) is preset.

The controller 80 first determines whether the printing mode is in the normal printing mode or the transposition printing mode. The controller 80 can determine the mode in various ways such as according to the mode inputted by the mode selecting part 60, the result sensed by the inferior nozzle sensor part (not shown), or preset contents.

As illustrated in FIG. 6, the printing medium S is shifted between the initial waiting position X1 and the transposition waiting position X2 by a distance as much as the expected shift amount ΔX. Here, W denotes a width of the printing medium in a transverse direction perpendicular to the feeding direction C of the printing medium. The printing medium S in the initial waiting position X1 is illustrated as dotted lines, and the printing medium in the transposition waiting position X2 is illustrated as a solid line. Here, the nozzles of the head 43 are arranged in the traverse direction and may have a length longer than the width of the printing medium in the traverse direction. FIG. 6 illustrates a row of the head 43 for the explanation purpose of the printing an image on the printing medium S. it is possible that a plurality of rows of the heads 43 are disposed in the feeding direction such that a plurality of nozzles can be used to print an image on the printing medium in the feeding direction and/or the traverse direction.

If it is determined that there is a problem in an image quality of the normally-printed image due to an inferior (or defective) nozzle R in the head 43 in a normal printing mode, the inferior nozzle R may be avoided by shifting the printing medium by a distance as much as the shift amount ΔX. At this time, the controller 80 can change the normal printing mode into the transposition printing mode by inputting the transposition printing mode through the mode selecting part 60, or automatically sensing the position of the inferior nozzle R by the controller 80.

If the printing mode is determined as the normal printing mode, the controller 80 determines whether the printing medium is in the initial waiting position X1 or the transposition waiting position X2. A position of the printing medium is determined from a rotational number of the first disk driving part 37 detected in the decoder (not illustrated) having decoded a signal of the encoder 38 of the transposition part 30. Here, if the printing medium is basically set to be in the initial waiting position X1, the operation of determining a position of the printing medium may be omitted.

If the printing medium is in the transposition waiting position X2 and the printing mode is the normal mode, the controller 80 controls the transposition part 30 to shift the printing medium to the initial waiting position X1.

After that, the controller 80 controls the medium transfer part 20 to drive the feed roller driving gear 21c of FIG. 2 to feed the printing medium in the initial waiting position X1 to the head 43 of the image forming part 40 and to perform normal printing.

If the printing mode is determined as the transposition printing mode, the controller 80 controls the transposition part 30 to shift the printing medium to the transposition waiting position X2.

Next, the controller 80 controls the medium transfer part 20 to drive the feed roller driving gear 21c of FIG. 2 to feed the printing medium in the transposition waiting position X2 to the head of the image forming part 40 to perform transposition printing.

According to the present general inventive concept, the ink jet printer 1 may have an image quality compensating mode in addition to the normal printing mode and the transposition printing mode.

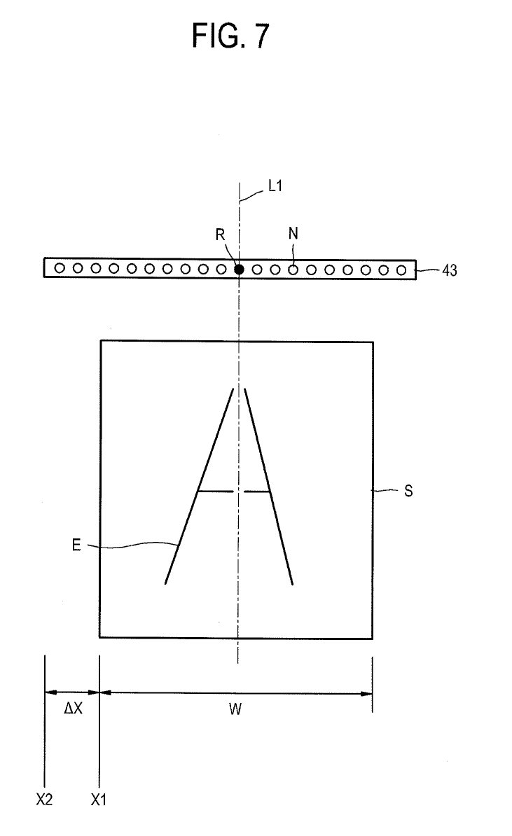

FIG. 7 is an exemplary view illustrating an outputted outcome in which an image blank is generated along an image area L1 due to the inferior (defective) nozzle R if, for example, image data “A” is supposed to be printed on the printing medium S. Also, a size of the nozzles N and R is illustrated larger than a real one in the exemplary views of the outputted outcome including FIG. 7 and the figures thereafter for convenience's sake.

As illustrated in FIG. 7, if there is an inferior (defective) nozzle R in a center area of the head 43, it is difficult to compensate for an image quality degradation caused by the inferior nozzle R through either of the normal printing mode and/or the transposition printing mode.

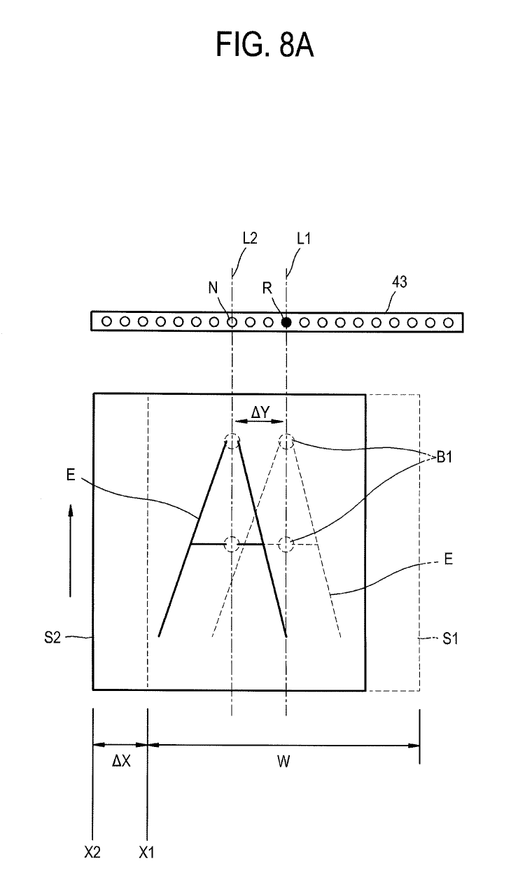

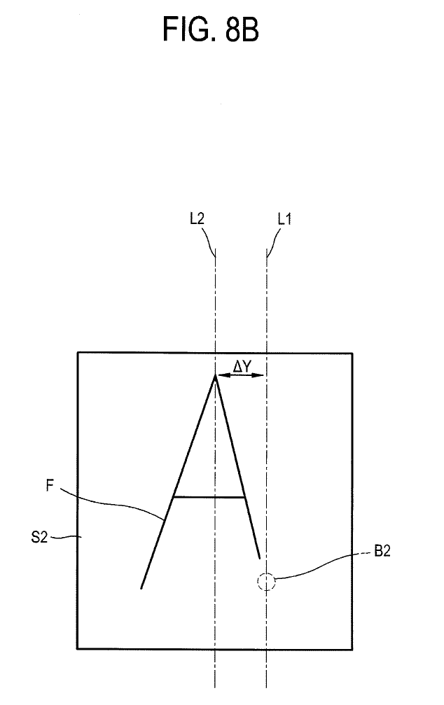

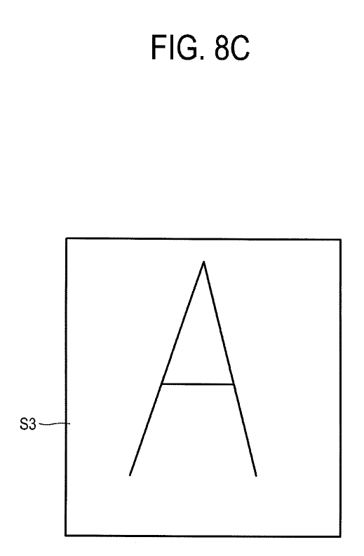

The image quality compensating mode can be used in a case that the image blank generated by the inferior nozzle R cannot be corrected through one of the normal printing mode and the transposition printing mode, or in a case that a high definition printing is needed. An operating process of the image quality compensating mode will be described by referring to FIGS. 8A to 8C.

As illustrated in FIG. 8A, if the printing mode is determined as the image quality compensating mode, the controller 80 first determines where the printing medium is between the initial waiting position X1 and the transposition waiting position X2. Here, if the printing medium is basically set to be in the initial waiting position X1, the operation of determining the waiting position of the printing medium may be omitted.

A signal of the encoder 38 of the transposition part 30 is decoded to detect the shifted amount H of FIG. 2 from the rotational angle of the first disk 32. Accordingly, it can be determined where the printing medium is between the initial waiting position X1 and the transposition waiting position X2. Also, a sensor may be further provided to sense the transposition shifting in the transverse direction of the printing medium, as necessary.

Waiting position information of the printing medium may be inputted by a user, if necessary.

First, as illustrated in FIG. 8A, the controller 80 controls the medium transfer part 20 to feed the printing medium S1 disposed in the initial waiting position X1, toward the image forming part 40. Accordingly, the normal printing is performed and a normal printing image E is formed on the printing medium S1. As illustrated in FIGS. 7 and 8A, the normally-printed image E has an image blank B1 along a line L1 in the image “A”.

After that, the controller 80 returns the printing medium S1 on which the normal printing image E is formed to the initial waiting position X1 by rotating the reverse roller 25 of FIG. 1 of the medium transfer part 20 of FIG. 1 in a reverse direction.

The controller 80 controls the transposition part 30 to shift the returned printing medium from the initial waiting position X1 to the transposition waiting position X2.

Next, the controller 80 controls the medium transfer part 20 to feed the printing medium S2 shifted to the transposition waiting position X2 to the image forming part 40.

Also, the controller 80 controls the image forming part 40 to form shift image data in which the image data of the normally-printed image E is shifted to the transverse direction by a distance as much as an image shift amount ΔY. Also, if the image shift amount ΔY is stored in the memory part, the stored image shift amount can be read out to be used to shift the printing medium.

Here, the image shift amount ΔY denotes a value corresponding to the expected shift amount ΔX of the printing medium according to the shifted amount H of the transposition shifting part 30. That is, if the expected shift amount ΔX of the printing medium is 0.01 inch or 0.25 mm and the nozzles of the image forming part 40 are disposed as much as 1200 dpi in the transverse direction, the image shift amount ΔY denotes 12 dots. Accordingly, nozzles in other positions spaced-apart by 12 dots from the nozzles forming the normal printing image can be used to perform the first transposition printing. Meanwhile, the image shift amount ΔY may have a dimension of a distance unit such as inch and mm. That's because it can be multiplied by resolution and converted into a dot unit.

As illustrated in FIG. 8B, the first transposition-printing image F according to the shifted image data is formed on the printing medium S2 disposed in the transposition waiting position X2 and formed with the normal printing image E. Here, the first transposition-printed image F has an image blank B2 along the line L1 by the inferior nozzle R. Also, the normally-printed image E is not illustrated in FIG. 8B.

The normally-printed image E and the first transposition-printed image F on the printing medium S2 shifted to the transposition waiting position X2 overlaps reciprocally, and thus, as illustrated in FIG. 8C, image blanks B1 and B2 caused by the inferior nozzle are corrected on the printing medium S3 of which the first transposition printing is completed to obtain a letter image “A” without a defective portion or a blank dot or line B1 or B2. The above-described printing method of the image compensating mode may be selected not only for compensating an inferior nozzle but also for a higher quality.

After the normal printing image E is first formed, the first transposition-printing image F which is superimposed on the normally-printed image E is formed. However, the normal printing image E may be formed after forming the first transposition-printing image.

According to the present embodiment, the first transposition-printing image F may be printed without shifting the same as much as the expected shift amount ΔX of the printing medium. In this case, the image shifted by a distance as much as the transposition amount ΔX may be overlappingly printed to intentionally form a distorted image. Such an image forming method may be utilized to distort a bill image by intentionally preventing a counterfeit bill.

Meanwhile, the ink jet printer 1 according to the present general inventive concept may further comprise an image quality deviation compensating mode for compensating for a problem in a case that deviation is generated between the shift amount ΔX of the real printing medium and the shifted amount H of the transposition shift part 30 in the above-described image compensating mode.

The image quality deviation compensating mode will be described by referring to FIGS. 9A and 9B.

According to a change of an operating circumstance such as abrasion, and a change of the transposition part 30 as time passes, the expected shift amount ΔX of FIG. 2 of the printing medium does not correspond to the original expected shifted amount H of FIG. 2 of the transposition part 30 to be different from each other.

If the image shift amount ΔY of the image forming part (see 40 in FIG. 1) is preset as a value corresponding to the shift amount ΔX of the printing medium, the normally-printed image E and the first transposition-printed image F are not reciprocally overlapped to depreciate sharpness of the image, as shown in FIG. 9B.

So as to compensate for this problem, the controller 80 first determines whether the printing mode corresponds to the image deviation compensating mode. That is, the controller 80 determines whether the image shift amount of the image forming part 40 needs to be corrected. It is preset so that the user can additionally select and input the image deviation compensating mode in the mode selecting part 60 of FIG. 6, and if there is a user's selection, it is determined as the image deviation compensating mode.

In a case that the image deviation is preset to be corrected at a predetermined time interval, it is automatically determined whether the predetermined time has passed to enter the image deviation compensating mode.

If it is determined as the image deviation compensating mode, the controller 80 detects a real shift amount ΔZ of the printing medium by using the scanning part 50.

For this purpose, as illustrated in FIG. 9A, the controller 80 feeds the printing medium S1 disposed in the initial waiting position X1 to the head 43 to form the normal printing image E thereon.

Also, the controller 80 controls the scanning part 50 to scan the printing medium S1 on which the normal printing image E is formed. The controller 80 returns the scanned printing medium S1 to the initial waiting position X1 again by reversing the reverse roller 25 of FIG. 1 of the medium transfer part 20.

Next, the controller 80 controls the transposition part 30 to shift the returned printing medium from the initial waiting position X1 to the transposition waiting position X2. However, the real printing medium may be shifted as much as an unknown real shift amount AZ different from the expected shift amount ΔX which indicates an interval between the initial waiting position X1 and the transposition waiting position X2.

Also, the controller 80 controls the medium transfer part 20 to feed the printing medium S4 shifted by a distance as much as the real shift amount AZ to the image forming part 40. At this time, the image forming part 40 does not shift the image data “A” of FIG. 9B of the normally-printed image E to form an image. That is, the image shift amount ΔY is preset as zero to form a second transposition-printing image G. As illustrated in FIG. 9A, the second transposition-printed image G is denoted as a solid line, and the normally-printed image E is denoted as dotted lines.

In addition, the second transposition-printed image G is scanned by the scanning part 50.

Accordingly, as illustrated in FIG. 9B, since a deviation ΔK in the transverse direction between the normally-printed image E and the second transposition-printed image G denotes the real shift amount ΔZ, the real shift amount ΔZ can be detected by using the two data E and G scanned by the scanning part 50. At this time, the scanning resolution of the scanning part 50 may be the same as or higher than the printing resolution of the image forming part 40.

Next, the controller 80 can compensate at least one of the shift amount and the image transposition amount stored in the memory part 70 of FIG. 5 by using the detected real shift amount ΔZ.

Meanwhile, since the real shift amount ΔZ by the transposition part 30 may be different according to a kind (a type) of the printing medium, the memory part 70 may store at least one of the expected shift amount and the image shift amount data according to the type of the printing medium.

Accordingly, the controller 80 may control the transposition part 30 of FIGS. 2 and 5 to first determine the type of the printing medium before shifting the printing medium. The type of the printing medium may be inputted through a medium type inputting part (not shown) by a user or may be determined by measuring an electric resistance of the printing medium. Here, the medium type inputting part may be provided as an inputting key (not shown) of the above-described mode selecting part 60.

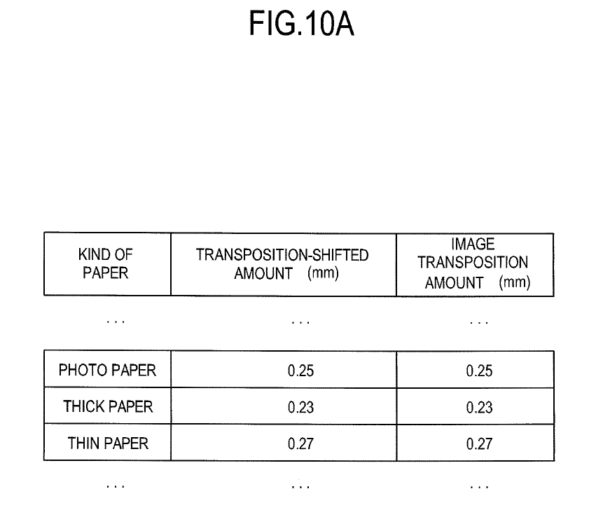

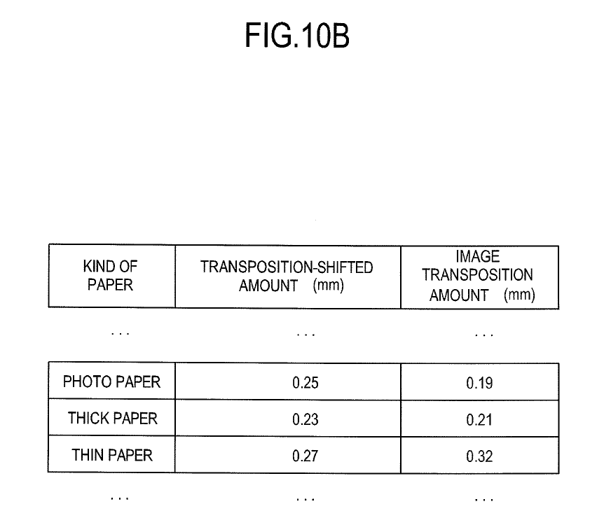

FIGS. 10A and 10B denote exemplary data formats stored in the memory part 70. The data formats are two data formats before and after compensation by using the detected real shift amount ΔZ, respectively.

As illustrated in FIG. 1A, the expected shift amount and the image shift amount may be preset differently according to a kind (or a type) of the printing medium. The type of the printing medium may be classified according to the manufacturing company of the printing medium, as necessary.

Meanwhile, the shift amount and the image shift amount may be set as a value outputted by the test. Also, as illustrated in FIG. 1A, the shift amount and the image shift amount may be provided to have the same value. As described above, since the real shift amount cannot be measured before use, the image shift amount may be set as the shift amount.

Also, as described above, if the real shift amount ΔZ of FIG. 9A is detected during an operating process, the detected real shift amount ΔZ can be stored as the image shift amount of the memory 70. For instance, if the detected real shift amount is 0.19 in a case of “a photo paper”, the detected real shift amount of 0.19 is newly stored to replace the conventional 0.25 to update the image shift amount.

Accordingly, it is possible to compensate the sharpness of the image, which may be deteriorated by a result of use or aging, for example, a mechanical property and wear and tear of the transposition part 30 even though printing is performed in the image quality compensating mode.

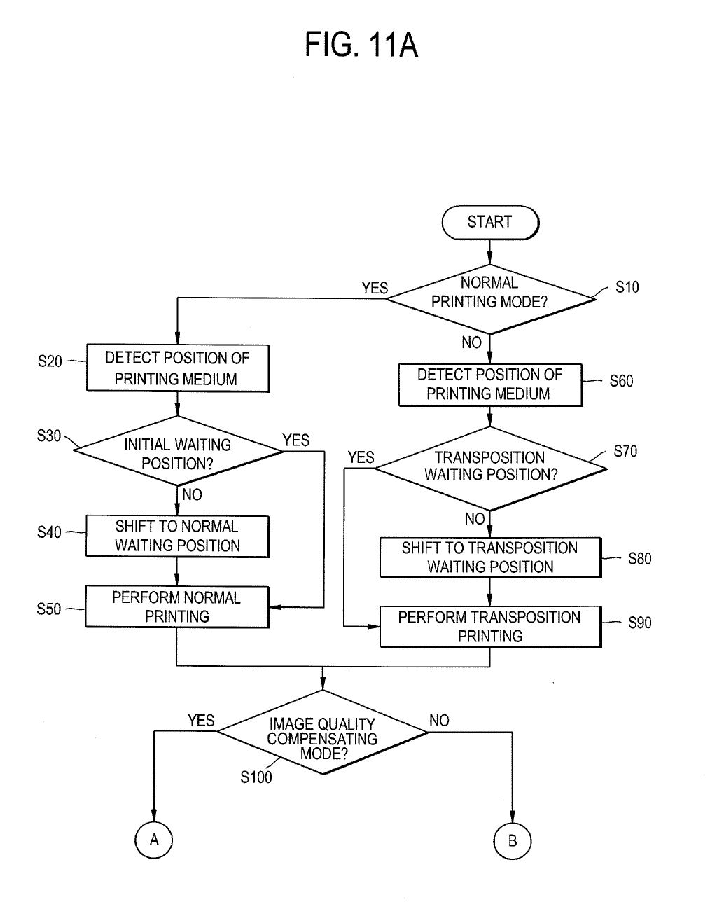

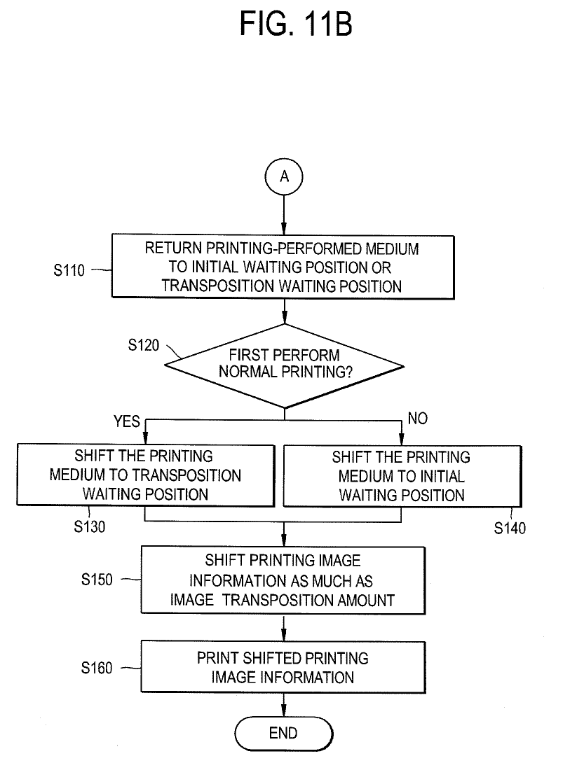

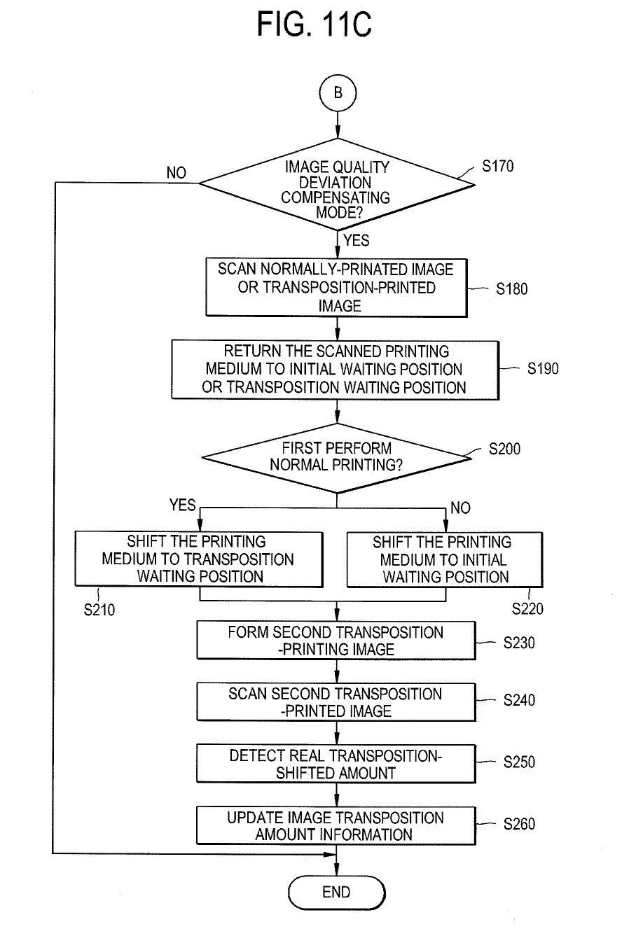

FIGS. 11A, 11B, and 11C are flow charts illustrating an image forming method of an ink jet printer according to an embodiment of the present general inventive concept. Here, the image forming method of FIGS. 11A, 11B, and 11C will be briefly described together with the controller 80 of the ink jet printer 1 of FIGS. 1 and 5.

Referring to FIGS. 1, 5, and 11A-11C, it is determined whether the printing mode is the normal printing mode at operation S10. Then, it is determined where the printing medium is positioned between the initial waiting position and the transposition waiting position shifted by a distance as much as the expected transposition amount from the initial waiting position to the transverse direction to the feeding direction of the printing medium at operation S20. The order of the operation S10 and the operation S20 may be changed, and in the case, operation S60 may be omitted. Further, if it is designed that the printing medium is supplied to the initial waiting position by the pick up roller 15 and the feeding roller 17, operations S20 through S40 may be omitted.

If the printing medium is not in the initial waiting position at operation S30, the printing medium is shifted to the initial waiting position at operation S40, and the printing medium shifted to the initial printing position is fed to the image forming part 40 of FIGS. 1 and 5 to perform an initial printing thereon at operation S50.

If the printing mode is determined as the transposition printing mode, the position of the printing medium is detected at operation S60, and if the printing medium is not in the transposition waiting position at operation S70, the printing medium is shifted to the transposition waiting position (at operation S80.

Also, the printing medium shifted to the transposition waiting position is fed to the image forming part 40 to perform a transposition printing thereon at operation S90.

In a case of the normal printing mode, an image is formed on the printing medium fed at the initial waiting position. In a case of the transposition printing mode, an image is formed on the printing medium fed at the transposition waiting position shifted by a distance as much as the transposition amount from the initial waiting position in the transverse direction perpendicular to the feeding direction of the printing medium.

As illustrated in FIG. 11C, if the normal printing and the transposition printing are completed, it is determined whether the printing mode in the image quality compensating mode at operation S100.

If the printing mode is determined as the image quality compensating mode, the printed medium is returned to the initial waiting position or the transposition waiting position at operation S110. Next, it is determined whether the returned printing medium is in the initial waiting position or the transposition waiting position at operation S120. If the normal printing has been first performed, the returned printing medium is supposed to be in the initial waiting position, and if the transposition printing has been first performed, the returned printing medium is supposed to be in the transposition waiting position. Accordingly, the operation S120 may be replaced with an operation of determining which printing has been first performed.

If the returned printing medium is in the initial waiting position, that is, if the normal printing has been first performed, the printing medium is shifted to the transposition waiting position at operation S130. On the other hand, if the returned printing medium is in the transposition waiting position, that is, if the transposition printing has been first performed, the printing medium is shifted to the initial waiting position at operation S140. Meanwhile, the image information in the first printing is shifted at operation S150 as much as the image shift amount corresponding to the shift amount between the initial waiting position and the transposition waiting position so that the same image can be overlappingly formed on the printing medium according to the image information. Here, the first printing denotes a first performed printing operation of the normal printing or the transposition printing.

Next, the shifted image information in the first printing is printed at operation S160.

Accordingly, a second printing is overlappingly performed on the first printed image, thereby compensating the inferior nozzle, and also obtaining a high definition.

As illustrated in FIG. 11C, if the printing mode is not in the image compensating mode, it is determined whether the printing mode is in the image deviation compensating mode at operation S170. In the case of the image deviation compensating mode, the first printed normally-printed image or transposition-printed image is scanned at operation S180.

The scanned printing medium is returned to the initial waiting position or the transposition waiting position at operation S190. Next, it is determined whether the returned printing medium is in the initial waiting position or the transposition waiting position at operation S200. If the normal printing has been first performed, the returned printing medium is supposed to be in the initial waiting position, and if the transposition printing has been first performed, the returned printing medium is supposed to be in the transposition waiting position. Accordingly the operation S120 may be replaced by determining which printing has been first performed at operation S200.

If the returned printing medium is in the initial waiting position, that is, if the normal printing has been first performed, the printing medium is shifted to the transposition waiting position at operation S210. If the returned printing medium is in the transposition waiting position, that is, if the transposition printing has been first performed, the printing medium is shifted to the initial waiting position at operation S220. Meanwhile, the image information which has been used in the first printing is not shifted but used to print as it is to form a second transposition-printing image at operation S230 so that the deviation can be displayed as much as the shift amount of the real printing medium on the normally-printed image or the transposition-printed image.

Next, the second transposition-printed image is scanned at operation S240.

The real shift amount of the printing medium is detected from the two scanned image data at operation S250.

Next, the image shift amount of the image quality compensating mode is updated by using the detected real shift amount at operation S260. That is, the image information in the first printing is shifted as much as the real transposition amount detected in the image quality compensating mode, so that a mechanical error caused by the transposition part 30 of FIG. 2 can be compensated.

If the memory part stores at least one of the shift amount and the image shift amount, the image shift amount can be updated by storing the detected real shift amount in the memory part as a value of the new image shift amount. Accordingly, in the image compensating mode, a shift image is formed corresponding to the real shift amount considering the mechanical error, thereby enhancing the sharpness of the image.

Meanwhile, the value of the image shift amount may be updated according to the type of the printing medium by determining the type of the printing medium in updating the image shift amount. For this purpose, a memory part may be provided to store at least one of the image shift amount and the expected shift amount according to the type of the printing medium.

The type of the printing medium may be inputted by a user or may be determined by measuring and comparing a resistance value of the printing medium with the data table of the printing medium type stored in advance. The resistance value may be a characteristic of the printing medium to represent the type of the printing medium.

As described above, the ink jet printer and the image forming method thereof according to the present general inventive concept have effects as follows.

First, a printing medium is shifted in a transverse direction perpendicular to the feeding direction to be printed.

Second, if there is an inferior (defective) nozzle, deterioration of the image quality caused by the nozzle can be corrected.

Third, various printing methods such as a normal printing mode, a transposition printing mode, and an image quality compensating mode can be provided.

Fourth, sharpness of the image quality due to abrasion of the transposition part and change of other operating conditions can be prevented from being deteriorated in the image quality compensating mode. The value of the image shift amount which has been preset upon release of the product to the market can be continuously updated into the real value of the shift amount of the printing medium. Accordingly, although the ink jet printer is used for a long period of time, the sharpness of the image quality can be continuously maintained.

Fifth, since a real shift amount is different according to the type of the printing medium, the difference can be considered. The image shift amount is stored according to the type of the printing medium to be updated, and accordingly, a relatively uniform image quality can be secured although the type of the printing medium is different.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of compensating for an image quality deviation in an image forming apparatus, the method comprising:
forming a first image on a printing medium fed at a first position;
shifting the printing medium having the first image in a transverse direction perpendicular to a feeding direction of the printing medium to the first position and a second position;
forming a second image on the printing medium fed at the second position; and
detecting a real shift amount of the printing medium by scanning the first and second images.

2. The method of claim 1, further comprising:
determining the type of printing medium.

3. The method of claim 1, further comprising:
storing the detected real shift amount according to the types of printing medium.

4. A method of forming an image in an image forming apparatus having an image forming part arranged wider than a feeding directional width of a printing medium, the method comprising:
determining whether a printing mode is in a normal printing mode or a transposition printing mode;
printing an image on a printing medium in the normal printing mode when the printing medium is in a first position;
printing the image on the printing medium shifted in a transverse direction perpendicular to a feeding direction of the printing medium in the transposition printing mode when the printing medium is in a second position shifted from the first position.

5. The method of claim 4, further comprising:
determining whether the printing mode is in an image quality deviation compensating mode; and
in case of the image quality deviation compensating mode, alternately printing first and second images on the printing medium according to the normal printing mode and the transposition printing mode, and detecting a real shift amount of the printing medium by scanning the first and second images.

6. The method of claim 5, further comprising:
determining the type of printing medium; and
storing the detected real shift amount according to the types of printing medium.

7. The method of claim 5, further comprising:
determining whether the printing mode is in an image compensating mode; and
in case of the image quality compensating mode, printing a third image and a fourth image shifted from the third image by a distance as much as the real shift amount on the printing medium according to the normal printing mode and the transposition printing mode.

8. The method of claim 6, further comprising:
determining whether the printing mode is in an image compensating mode; and
in case of the image quality compensating mode, printing a third image and a fourth image shifted from the third image by a distance as much as the real shift amount on the printing medium according to the normal printing mode and the transposition printing mode.

9. An image forming apparatus comprising:
an image forming part which is arranged wider than a feeding directional width of a printing medium to form an image;
a transposition part which shifts the printing medium in a transverse direction perpendicular to a feeding direction of the printing medium to a first position and a second position;
a scanning part which scans an image formed by the image forming part; and
a controller which controls the image forming part, the transposition part and the scanning part to form a first image and a second image on the printing medium fed from a first position and a second position spaced apart from the first position in the transverse direction by a distance as much as the shift amount, respectively, and to detect a real shift amount by scanning the first image and the second image.

10. The image forming apparatus of claim 9, further comprising:
a memory part,
wherein the controller determines the type of printing medium and stores the real shift amount according to the determined type of printing medium in the memory part.

11. The image forming apparatus of claim 9, wherein, in an image quality compensating mode, the controller controls the image forming part and the transposition part to print a first image on the printing medium fed at the first position, to shift the print medium on which the first image is printed, and to print a second image shifted from the first image as much as the real shift amount on the shifted printing medium.

12. An image forming apparatus comprising:
an image forming part having a length wider than a feeding directional width of a printing medium;
a transposition part to shift the printing medium in a transverse direction perpendicular to a feeding direction of the printing medium to a first position and a second position; and
a controller to determine whether a printing mode is in a normal printing mode or a transposition printing mode, to control the image forming part to print an image on the printing medium in the normal printing mode, and to print the image on the printing medium shifted in the transverse direction in the transposition printing mode.

13. An image forming apparatus comprising:
an image forming part;
a feeding roller to feed a printing medium; and
a driving unit connected to the feeding roller to rotate the feeding roller about a rotation axis of the feeding roller, and to selectively shift the feeding roller in a direction of the rotation axis of the feeding roller.
